(19) United States
(12) Patent Application Publication
(10) Pub. No.: US 2024/0354740 A1
(43) Pub. Date: Oct. 24, 2024

(54) A STORED VALUE CARD VALIDATION SYSTEM

(71) Applicant: 545490 PTY. LTD., Surry Hills (AU)

(72) Inventor: David Anderson, Surry Hills (AU)

(21) Appl. No.: 18/684,424

(22) PCT Filed: Aug. 11, 2022
(86) PCT No.: PCT/AU2022/050878

§ 371 Date: Feb. 16, 2024

(30) Foreign Application Priority Data
Aug. 17, 2021 (AU) 2021105636
Aug. 17, 2021 (AU) 2021902554
May 25, 2022 (AU) 2022901409

(51) Int. Cl. G06Q 20/34; G06Q 20/28; G06Q 20/40

(52) U.S. Cl. CPC G06Q 20/341; G06Q 20/28; G06Q 20/354; G06Q 20/401

(57) ABSTRACT

There is provided a stored value card validation system. The system includes a stored value card having a plurality of activation states including an activated state where the card can be utilised in a purchase transaction and an unactivated state where the card cannot be utilised in a purchase transaction. The stored value card includes a single unique encrypted token, along with a predefined card value in the form of a monetary amount and a card identifier which are both contained in the encrypted token. The system also includes a token reader for retrieving the encrypted token from the stored value card. Further, the system includes a token validator in communication with the token reader for receiving the encrypted token and using the encrypted token to validate the predefined card value and the card identifier. The token validator includes a plurality of databases for storing card value information and card identifier information, wherein the predefined card value and the card identifier are each validated based on the card value information and card identifier information, most notably, when the stored value card is in the unactivated state.

### TECHNICAL FIELD

The present disclosure relates to a stored value card validation system. The present disclosure has applications to cashless monetary transactions, that is non-cash payments, in the field of retail goods and services.

While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Stored value cards, for example gift cards or travel cards, have been commonplace for a number of years, in particular for use in purchasing retail goods and services. Stored value cards are essentially a payment card that is able to store within it, monetary value that can be accessed directly from the card for purchases. Such stored value cards can take a number of different forms, such as specific cards issued by a certain merchant for use with that merchant only, cards where the stored value can be redeemed at a number of different merchants within a geographical zone, or cards where the stored value can be redeemed at a number of different merchants within a certain merchant category code (MCC), for example cafes and restaurants.

Traditionally, the only data stored on a stored value card is the monetary amount, which is exclusively stored on the card.

There are two main forms of known stored value cards, those being cards where:
1) The card data is accessible via an encoded magnetic stripe or barcode that is directly connected to a point of sale (POS) system. In this case, the card itself only requires the POS system to function.
2) The card data is stored on a third-party server that is connected to a POS system.

For both of these known types of stored value card, to access the monetary value or even check the monetary value of known stored value cards, there is a need to activate the card. Such activation generally includes interaction with a POS system, for example, to use the stored value card to actually initiate a financial transaction with a POS system. Known stored value cards and their associated system allow a consumer to check a stored value card say prior to such an interaction.

Whilst some security measures are in place, such as scratch off areas on cards to reveal activation codes (also known as a security personal identification number or “PIN”) that prevent unauthorized activation or duplication of card, there are many other potential security risks for known stored value card systems. For example, if a consumer was to purchase a gift card, there is presently no ability to check that such a card actually possesses the value that its packaging may indicate prior to the purchase of that card. Such a limitation enables fraudulent or counterfeit cards to be packaged as legitimate stored value cards and sold to a consumer without allow for any prior checks of the legitimacy of the card.

Further, as indicated above, known stored value cards require identifying data printed on the card in order to provide a level of card security, including one or more of a card number (physically printed on the card), a barcode, a personal access number (PAN), card verification value (CVV), expiry date and/or security PIN.

### SUMMARY

It is an object of the present invention to overcome or ameliorate at least one of the disadvantages of the prior art, or to provide a useful alternative.

In accordance with a first aspect of the present invention there is provided a stored value card validation system including:
a stored value card having a plurality of activation states including an activated state and an unactivated state, the stored value card including: an encrypted token; a predefined card value; and a card identifier, whereby the predefined card value can be utilised for a transaction if the card is in the activated state and cannot be utilised for a transaction if the card is in the unactivated state;
a token reader for retrieving the encrypted token from the stored value card; and
a token validator in communication with the token reader for receiving the encrypted token and using the encrypted token to validate the predefined card value and the card identifier, the token validator having at least one database for storing card value information and card identifier information, wherein the predefined card value and the card identifier are each validated based on the card value information and card identifier information when the stored value card is in the unactivated state, further wherein the stored value card is able to be activated and/or validated without being connected to a registered user of the system.

In an embodiment, the token reader includes a display for outputting a status of the stored value card, wherein the status is one of: a validated status whereby the predefined card value and the card identifier are successfully validated; and an unvalidated status whereby the predefined card value and the card identifier not successfully validated.

In an embodiment, the stored value card includes a QR code and the token reader retrieves the token by reading the QR code.

In an embodiment, the stored value card includes a magnetic stripe and the token reader retrieves the token by reading the magnetic stripe.

In an embodiment, the stored value card includes an embedded passive RFID tag and the token reader retrieves the token by reading the RFID tag.

In an embodiment, the stored value card includes an embedded active transmitter and the token reader retrieves the token by receiving a transmitted signal from the transmitter.

In an embodiment, the card value validation system includes a secure communication channel for facilitating communication between the token reader and the token validator.

In an embodiment, the token reader is a smartphone having a dedicated reader software application.

In an embodiment, the token reader is a scanning device coupled to a computer system.

In an embodiment, the token reader is a scanning device coupled to a kiosk.

In an embodiment, the predefined card value and the card identifier are each validated based on the card value information and card identifier information when the stored value card is in the activated state.

In accordance with a second aspect of the present invention there is provided a method for validating a stored value card having a plurality of activation states including an activated state and an unactivated state, the stored value card including: an encrypted token; a predefined card value; and a card identifier, whereby the predefined card value can be utilised for a transaction if the card is in the activated state and cannot be utilised for a transaction if the card is in the unactivated state, the method including the steps of:
retrieving, by a token reader, the encrypted token from the stored value card;
receiving, by a token validator in communication with the token reader, the encrypted token; and
validating, by the token validator using the encrypted token, the predefined card value and the card identifier, the token validator having at least one database for storing card value information and card identifier information, wherein the predefined card value and the card identifier are each validated based on the card value information and card identifier information when the stored value card is in the unactivated state, further wherein the stored value card is able to be activated and/or validated without being connected to a registered user of the system.

In an embodiment, the token reader includes a display, the method includes the further step of:
outputting on the display a status of the stored value card, wherein the status is one of: a validated status whereby the predefined card value and the card identifier are successfully validated; and an unvalidated status whereby the predefined card value and the card identifier not successfully validated.

In an embodiment, the stored value card includes a QR code and the retrieving step includes the token reader retrieving the token by reading the QR code.

In an embodiment, the stored value card includes a magnetic stripe and the retrieving step includes the token reader retrieving the token by reading the magnetic stripe.

In an embodiment, the stored value card includes an embedded passive RFID tag and the retrieving step includes the token reader retrieving the token by reading the RFID tag.

In an embodiment, the stored value card includes an embedded active transmitter and the retrieving step includes the token reader retrieving the token by receiving a transmitted signal from the transmitter.

In an embodiment, communication between the token reader and the token validator is facilitated by a secure communication channel.

In an embodiment, the token reader is a smartphone having a dedicated reader software application.

In an embodiment, the token reader is a scanning device coupled to a computer system.

In an embodiment, the token reader is a scanning device coupled to a kiosk.

In an embodiment, the predefined card value and the card identifier are each validated based on the card value information and card identifier information when the stored value card is in the activated state.

Other aspects of the present disclosure are also provided.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may be in some appropriate cases. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

One or more embodiments of the present disclosure will now be described by way of specific example(s) with reference to the accompanying drawings, in which:

FIG. 1 is a block diagram of a stored value card validation system according to an embodiment of the invention;

FIG. 2 is a block diagram of a computing system with which various embodiments of the present disclosure can be implemented/configurable to perform various features of the present disclosure; and

FIG. 3 is a flow chart of the process of using the stored value card validation system of FIG. 1.

### DETAILED DESCRIPTION

Where applicable, steps or features in the accompanying drawings that have the same reference numerals are to be considered to have the same function(s) or operation(s), unless the contrary intention is expressed or implied.

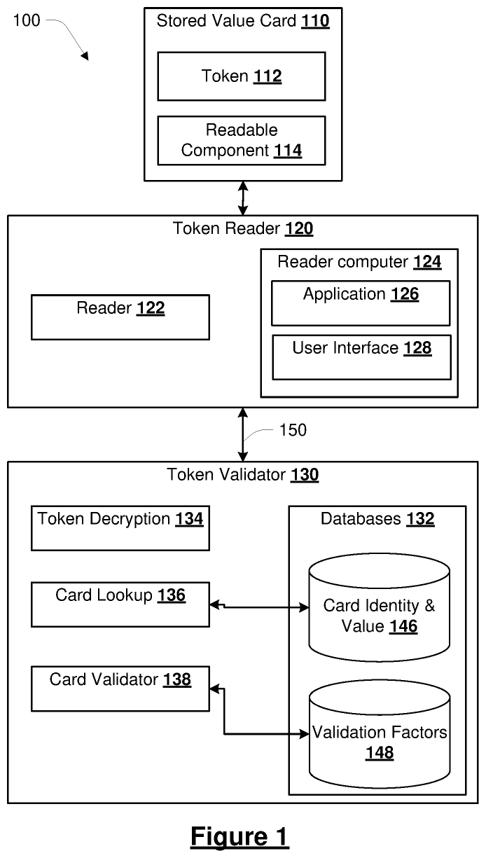

Referring initially to FIG. 1, there is illustrated a stored value card validation system 100. System 100 includes a stored value card 110 having a plurality of activation states including an activated state where the card can be utilised in a purchase transaction and an unactivated state where the card cannot be utilised in a purchase transaction. Stored value card 110 includes a single unique encrypted token 112, along with a predefined card value in the form of a monetary amount and a card identifier which are both contained in encrypted token 112. System 100 also includes a token reader 120 for retrieving encrypted token 112 from stored value card 110. Further, system 100 includes a token validator 130 in communication with token reader 120 for receiving encrypted token 112 and using encrypted token 112 to validate the predefined card value and the card identifier. Token validator 130 includes a plurality of databases 132 for storing card value information and card identifier information, wherein the predefined card value and the card identifier are each validated based on the card value information and card identifier information, most notably, when the stored value card is in the unactivated state.

Stored value card 110 is a physical card, having the dimensions of a standard sized credit card. However, in other embodiments, the card is of different shape a dimension. The card identifier takes the form of a unique number assigned to the specific stored value card 110. In other embodiments, card identifier is another unique identifier other than or additional to a unique number. Stored value card 110 will be sold by a card vendor and that vendor will also provide the card identifier, the predefined card value and the card state (usually unactivated). Stored value card 110 includes a readable component 114 for enabling access to encrypted token 112. Readable component 114 includes one or more of:
A QR code printed on stored value card 110;
A magnetic stripe printed on stored value card 110;
A passive radio-frequency identification (RFID) tag embedded within stored value card 110; and
An active transmitter, such as a transponder or beacon, embedded within stored value card 110.

Encrypted token 112 provides a link between stored value card 110 and databases 132 that, as noted above, stores all the relevant information related to stored value card 110, that relevant information including the monetary amount and the card identifier. Therefore, accessing the data of stored value card 110 (including access to the value or monetary amount of stored value card 110,) is through encrypted token 112 which is required to retrieve the data from databases 132 (this will be explained in more detail below).

As will be appreciated by those skilled in the art, encrypted token 112 therefore provides two layers of security that must be overcome to access the information on, or related to, stored value card 110, those being: the encryption of the token; and the use of tokenisation itself.

As noted above, stored value card 110 has a plurality of activation states including an activated state where the card can be used in a purchase transaction and an unactivated state where the card cannot be used in a purchase transaction.

Stored value card 110 is immediately activated upon completion of the purchase of the card by a consumer, for example via a retail POS where the retailer purchases the cards from the card vendor. In alternative embodiments, stored value card 110 is sold to a consumer directly via their phone (either from merchant or vendor) and subsequently activated on completion of the payment for the card. In other words, the purchase and activation of stored value card 110 are completed together and there is no separate action for a consumer to complete in order to activate stored value card 110. As such, stored value card 110 is in the unactivated state prior to its purchase by the consumer, and stored value card 110 is in the activated state following its purchase by the consumer. In other embodiments, stored value card 110 is automatically activated at the time of the first use of stored value card 110 for purchasing a good or service. In yet other embodiments, stored value card 110 must be activated manually prior to the first use of stored value card 110 for purchasing a good or service. It will be appreciated that stored value card 110 is unassigned, meaning that in order to be activated and/or validated it does not need to be specifically connected (or assigned) to, say, a registered consumer account within token validator 130. In other words, the card identifier does not need to be connected to a registered consumer account.

Token reader 120 includes a reader component 122 in the form of a physical device for reading readable component 114. Depending on the form of readable component 114, reader component 122 will take the form of a compatible reader of that readable component. For example:
Where readable component 114 is a QR code, reader component 122 is a QR reader scanning device for reading the QR code;
Where readable component 114 is a magnetic stripe, reader component 122 is a magnetic stripe reader scanning device for reading the magnetic stripe;
Where readable component 114 is an embedded passive RFID tag, reader component 122 is a RFID reader scanning device for reading the RFID tag; and
Where readable component 114 is an embedded active transmitter, reader component 122 is a receiver device that is able to both seek an active transmitted signal from stored value card 110 (if the active transmitter is a transponder) or receive in the first instance an active transmitted signal from stored value card 110 (if the active transmitter is a beacon).

Token reader 120 includes a reader computer 124 that is coupled to reader component 122. Reader computer 124 will be described in more detail below, but includes hardware such as a processor and memory as well as software that is executable by the hardware. The software includes a dedicated reader software application 126 that includes instructions for the hardware to read readable component 114. Reader computer 124 also includes a user interface 128 for facilitating interaction with a user, and includes input components such as a keyboard, mouse and/or touchscreen and output components such as a display. The display is used for outputting a status of the stored value card, and also encompasses any visual notification on reader computer 124 along with any associated peripheral device including smart watches, HUD glasses, amongst others. Further, in other embodiments, notifications include an aural and/or tactile component.

In preferred embodiments, reader computer 124 and reader component 122 are integrated into the same single device, such as a smartphone where an inbuilt camera acts as the reader component. Where a consumer's own smartphone is used as a single integrated device, reader application 126 can be set up to include an account for that consumer's device. The consumer account will be set up using details entered into reader application 126 including name (first name and surname), email, telephone number, and password, amongst others.

In other embodiments, token reader 120 includes a scanner of which examples are set out above (the reader component) coupled to a desktop or laptop computer. In other embodiments, token reader 120 includes a scanner of which examples are set out above (the reader component) coupled to a kiosk which itself includes an integrated computing device along with other point of sale (POS) components such as cash registers. It will be appreciated that, in other embodiments, other appropriate computing devices are utilized such as a tablet computer or PDA. It will be appreciated that reader computer 124 will also have other applications installed/running thereon, for example an operating system.

By reading readable component 114, token reader 120 is able to retrieve encrypted token 112.

Token reader 120, in particular reader computer 124, is in communication with token validator 130 by way of a secure communication channel 150. Secure communication channel 150 exists within a local area network, public network (for example, the Internet), or a combination of both, of which both token reader 120 and token validator 130 have access. However, in other embodiments, other types of communications networks are utilised, such as a hardwired network. The data transmitted over secure communication channel 150 is itself encrypted, which is in addition to the encryption of encrypted token 112 itself.

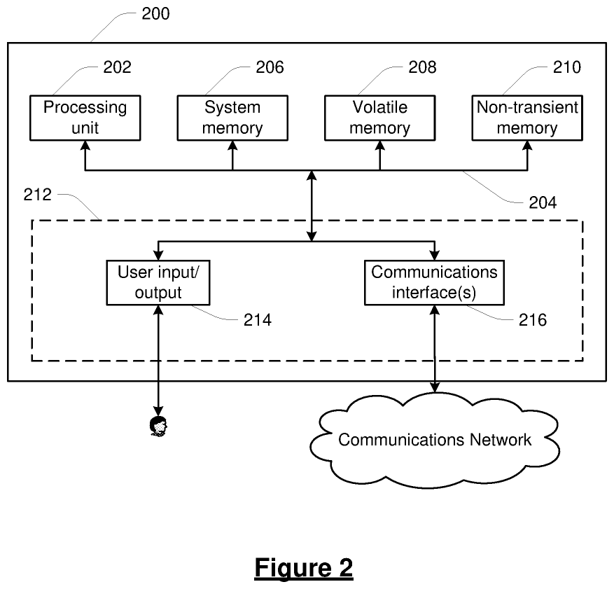

FIG. 2 provides a block diagram of a computer processing system 200 configurable to perform various functions described herein, for example the functions of reader computer 124. System 200 is a general purpose computer processing system. It will be appreciated that FIG. 2 does not illustrate all functional or physical components of a computer processing system. For example, no power supply or power supply interface has been depicted. However, system 200 will either carry a power supply or be configured for connection to a power supply (or both). It will also be appreciated that the particular type of computer processing system will determine the appropriate hardware and architecture, and in some embodiments alternative computer processing systems suitable for implementing features of the present disclosure will have additional, alternative, or fewer components than those depicted.

Computer processing system 200 includes at least one processing unit 202. In some embodiments, processing unit 202 is a single computer processing device (for example, a central processing unit, graphics processing unit, or other computational device). In other embodiments, processing unit 202 includes a plurality of computer processing devices. In some embodiments, where system 200 is described as performing an operation or function, all processing required to perform that operation or function will be performed by processing unit 202. In other embodiments, processing required to perform that operation or function is also performed by remote processing devices accessible to and useable by (either in a shared or dedicated manner) system 200.

Through a communications bus 204, processing unit 202 is in data communication with a one or more machine readable storage (memory) devices which store instructions and/or data for controlling operation of system 200. In various embodiments, system 200 includes one or more of: a system memory 206 (for example, resident set-size memory), volatile memory 208 (for example, random access memory), and non-volatile or non-transitory memory 210 (for example, one or more hard disk or solid-state drives). Such memory devices may also be referred to as computer readable storage media.

System 200 also includes one or more interfaces, indicated generally by reference 212, via which system 200 interfaces with various devices and/or networks. Generally speaking, in various embodiments, other devices are integral with system 200, or are separate. Where a device is separate from system 200, connection between the device and system 200, in various embodiments, is via wired or wireless hardware and communication protocols, and are a direct or an indirect (for example, networked) connection.

Wired connection with other devices/networks is facilitated by any appropriate standard or proprietary hardware and connectivity protocols. For example, in various embodiments, system 200 is be configured for wired connection with other devices/communications networks by one or more of: USB; FireWire; Ethernet; HDMI; and other wired connection interfaces.

Wireless connection with other devices/networks is similarly facilitated by any appropriate standard or proprietary hardware and communications protocols. For example, in various embodiments, system 200 is configured for wireless connection with other devices/communications networks using one or more of: infrared; Bluetooth; Wi-Fi; near field communications (NFC); Global System for Mobile Communications (GSM); Enhanced Data GSM Environment (EDGE); long term evolution (LTE); and other wireless connection protocols.

Generally speaking, and depending on the particular system in question, devices to which system 200 connects (whether by wired or wireless means) include one or more input devices to allow data to be input into/received by system 200 for processing by processing unit 202, and one or more output device to allow data to be output by system 200. A number of example devices are described below. However, it will be appreciated that, in various embodiments, not all computer processing systems will include all mentioned devices, and that additional and alternative devices to those mentioned are used.

Referring to reference 214, in one embodiment, system 200 includes or connects to one or more input devices by which information/data is input into (received by) system 200, with one or more of these devices contributing to user interface 128. Such input devices include keyboards, mice, trackpads, microphones, accelerometers, proximity sensors, GPS devices and the like. System 200, in various embodiments, further includes or connects to one or more output devices controlled by system 200 to output information. Such output devices include devices such as a cathode ray tube (CRT) displays, liquid-crystal displays (LCDs), light-emitting diode (LED) displays, plasma displays, touch screen displays, speakers, vibration modules, LEDs/other lights, amongst others. In embodiments, system 200 includes or connects to devices which are able to act as both input and output devices, for example memory devices (hard drives, solid state drives, disk drives, compact flash cards, SD cards and the like) which system 200 can read data from and/or write data to, and touch screen displays which can both display (output) data and receive touch signals (input).

System 200 also includes one or more communications interfaces 216 for communication with a network, such as the network that facilitates secure communication channel 150. Via the communications interface(s) 216, system 200 can communicate data to and receive data from networked devices, which in some embodiments are themselves other computer processing systems.

System 200 stores or has access to computer applications (also referred to as software, applications or programs), such as reader application 126. These are also described as computer readable instructions and data which, when executed by the processing unit 202, configure system 200 to receive, process, and output data. Instructions and data are able to be stored on non-transient machine readable medium accessible to system 200. For example, in an embodiment, instructions and data are stored on non-transient memory 210. Instructions and data are able to be transmitted to/received by system 200 via a data signal in a transmission channel enabled (for example) by a wired or wireless network connection over interface such as 212.

Applications accessible to system 200 typically includes an operating system application such as Windows, macOS, iOS, Android, Unix, Linux, or other operating system.

Token validator 130 takes the form of a server-side computer that includes hardware such as a processor and memory as well as software that is executable by the hardware. As noted above, token validator 130 includes databases 132, which more specifically includes a card identity and value database 146 and a validation factors database 148. Token validator 130 includes a token decryption module 134 for decrypting encrypted token 112. The decrypted token is then in a form to be inputted into a card lookup module 136. Card lookup module 136 is coupled to card identity and value database 146 that stores the card value information, that is the monetary amount of stored value card 110, and the card identifier information, that is the card identifier of stored value card 110. Card lookup module 136 is able to query card identity and value database 146 using the decrypted token to locate and retrieve, from the card identifier information, the corresponding card identifier of stored value card 110, and from the card value information, the present monetary amount of stored value card 110.

Further, token validator 130 includes a card validation module 138 coupled to validation factors database 148. Card validation module 138 is able to query validation factors database 148 using the card identifier to locate and retrieve further relevant card validation information that is stored in validation factors database 148, such as:
An activation state, that is one of: activated; or unactivated;
Time stamp information in relation to a validation request on a certain token reader 120 (such as a certain smartphone), which includes the specific time and date of any previous validation query of token validator 130;
Location information in relation to a validation request of a certain token reader 120 (such as a certain smartphone), which includes the specific location (within a certain distance) of any previous validation query of token validator 130;
Other historical data associated with stored value card 110 and/or token reader 120. For example, encrypted token 112 can be associated with a certain token reader 120 (such as a certain smartphone) when store value card 110 is requested to be validated with that certain device, and token validator 130 will associate the specific token with that specific device for subsequent requests, this information being stored in validation factors database 148.

The information in validation factors database 148 allows further validation methods to be implemented to provide yet further security checking of stored value card 110. Such methods include:
Comparison of activation state provided by the card vendor;
Comparison against value provided by the card vendor;
Comparison of the remaining balance provided by the card vendor;
Comparison of the timing and originating location of the validation request;
Comparison of the timing and location of the previous validation requests for the same card identification;
Current and historical data associated with the device on which the token reading system; and/or
Comparison against other patterns and historical aggregated information.

Stored value card 110 including encrypted token 112, is created by the card vendor. Further, the card vendor hosts and maintains token validator 130 including databases 132. As such, the card vendor maintains control of the card identifier and card value of each stored value card 110 that the card vendor produces.

In embodiments where a consumer's own smartphone is used and with a corresponding consumer account, when store value card 110 is purchased, the card identifier is accessed by reading the card using the smartphone (token reader 120) and, once read, reader application 126 will prompt the consumer to register store value card 110 to the consumer account in order to link store value card 110 to that specific consumer through that specific smartphone. Once registered, a virtual card representing stored value card 110 will be viewable in reader application 126, the virtual card including the card value (or balance) and other details including PAN, CVV and expiry date.

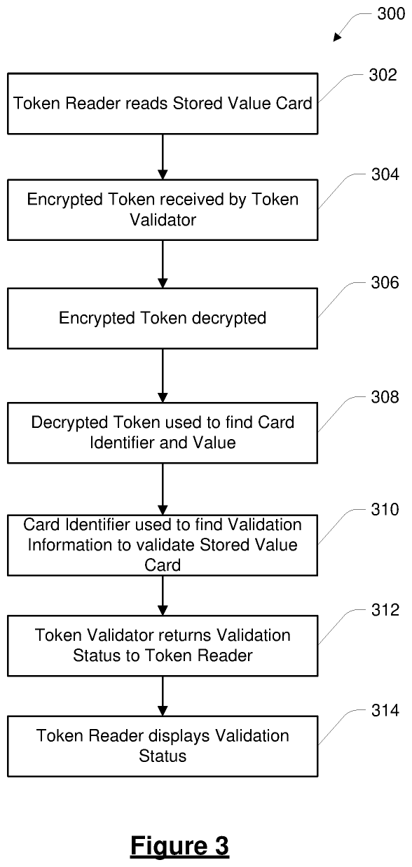

Referring to FIG. 3, there is illustrated a process 300 of validating stored value card 110 by system 100. At 302, stored value card 110 is read by token reader component 122 in order to retrieve encrypted token 112. This is done by physically positioning stored value card 110 and/or reader component 122 within a certain proximity and position so that the particular interaction is able to occur. It will be appreciated that the specific positioning will depend on the type of readable component 114 on stored value card 110 and the corresponding compatible type of reader component 122. For example, for a QR code, the QR reader scanning device will be held close to and aimed at the QR code. For a magnetic stripe, stored value card 110 will be swiped along the magnetic stripe reader scanning device such that the magnetic stripe slidingly engages the reader magnetic stripe reader scanning device. For an embedded passive RFID tag or an embedded active transmitter, stored value card 110 is held within a certain proximity of reader component 122 for up to a few seconds.

At 304, the retrieved encrypted token 112 is sent by token reader 120 over secure communication channel 150 to token validator 130 where it is received. At 306, encrypted token 112 is decrypted by token decryption module 134 to yield a decrypted token. It will be appreciated that in alternate embodiments, the decryption functionality will be included in token reader 120 and the encrypted token 112 will be decrypted by token reader 120 with the decrypted token being sent to token validator 130.

At 308, the decrypted token is inputted into card lookup module 136 which queries card identity and value database 146 and returns the card identifier and the present card value, that is the remaining monetary amount on stored value card 110.

At 310, card validation module 138 will use the card identifier returned by card lookup module 136 to query validation factors database 148 and returns further relevant card validation information. For example, an activation state of either “activated” or “not activated” is returned and can be compared to the activation state as understood by the consumer. Alternatively or in addition (depending on the specific embodiment), a card value is returned and can be compared to the understood monetary amount on the card, such as the predefined card value or a remaining balance where stored value card 110 has been used. Alternatively or in addition (depending on the specific embodiment), if stored value card 110 has been used or validated previously, the time and/or location of that validation request can be compared to the time and place of the last validation request as understood by the consumer.

Based on the outcomes of 310, at 312, token validator 130 returns a card status to token reader 120 which is one of: a “validated” status where the card identifier and value of stored value card 110 is verified as being correct and legitimate; or a “not validated” status where either of the card identifier and value of stored value card 110 is not found to match what is provided by the card vendor or if the requisite information cannot be attained from databases 132 from the reading of the card. For example, a consumer may wish to purchase what they believe to be a brand new stored value card 110 and when a validation request is made, token validator 130 returns that the card has actually has an activation state of “activated” and a card value of $0, therefore a “not validated” status is returned. Another example of a “not validated” status being returned is due to the card being totally fraudulent and, therefore, the card does not contain an encrypted token and/or the information on the card yields no result from the querying of databases 132. At 314, the card status is relayed and displayed to the consumer. In various embodiments, the card status is relayed to the consumer by one or more of the following means: SMS; email; smartphone push notifications; in-app notifications; or other utilities such as App Clips and Instant Apps. In other words, the display of user interface 128 outputs the card status.

With the data collected from any device that reads encrypted token 112 (that is any certain token reader 120) the vendor that is in control of token validator 130 is also able to take action in response to fraudulent or suspicious behaviours in relation to the use of a specific stored value card 110. For example, card can be marked and/or frozen through token validator 130 in response to certain behaviours that may indicate fraud. A specific example of a behaviour that would be suspicious is single mobile device scanning hundreds of cards within a relatively short finite time period or that same device scanning cards across multiple locations. This data is not actually kept on stored value card 110 but a connection of cards, consumer devices and servers would be utilised to triangulate that information.

In respect of the relationship between token reader 120 and token validator 130, in terms of architecture, the communications and interactions generally reflect a client/server relationship whereby token reader 120 is a client-side device and token validator 130 is a server side device.

When executed by reader computer 124 (for example, by a processing unit such as 202), the reader application 126 configures token reader 120 to provide client-side reader functionality. This involves communicating (using secure communication channel 150) with the token validator 130. In embodiments, reader application 126 is a dedicated application client that communicates with token validator 130 using an application programming interface (API). Alternatively, in other embodiments, reader application 126 is a web browser (such as Chrome, Safari, Internet Explorer, Firefox, or an alternative web browser) which communicates with a web server of token validator 130 (or token validator 130 itself being a web server) using http/https protocols over secure communication channel 150, https protocols being known as encrypted web traffic as mentioned above. In other similar embodiments, system 100 utilises cloud-based system architecture, for example, where elements of token validator 130 and potentially token reader 120 (such as the processing elements) are cloud-based.

Furthermore, while a single token reader 120 has been depicted, system 100 will typically include multiple token readers 120, each configured in a similar fashion to interact with token validator 130. Further, token validator 130 is configured to provide server-side functionality for each of the end users by way of the one or multiple token readers 120, by receiving and responding to requests from the one or multiple token readers 120. In embodiments where reader application 126 is a web browser, token validator 130 includes a web server (for interacting with the web browser clients). Otherwise, token validator 130 includes an application server (such as a network available applications service including a service providing API using web protocols, for example, http/https or gRPC) for interacting with dedicated application clients by way of reader application 126. While token validator 130 has been illustrated as a single server, in other embodiments, token validator 130 consists of multiple servers (for example, one or more web servers and/or one or more application servers).

### Advantages of Detailed Embodiments

It will be appreciated that the embodiments of system 100 described herein are advantageous over known systems as it has been devised to address the security issues that exist with known stored value cards. More specifically, system 100 achieves the following advantages:
Whilst some embodiments include a POS system, there is not strict requirement of access to a POS system in order to validate stored value card 110.
Allowing the validation of stored value card 110, including activation state, card identifier and stored value, without the initiation of financial transaction.
Does not require a security PIN or other printed data on the card itself. For known stored value card, the security PINs are inaccessible prior to purchasing the card and, therefore, a consumer can not verify the status of a card without access to this. The absence of such a measure is crucial to facilitating the validation of the card before activation and before purchase.
The card tokenisation and encryption of store value card 110 allows the consumer to check the status of a card prior to purchase and instantly access the card identifier via digital means after the card has been purchased.
Improved security features in the form of the encrypted token, which is intrinsic to stored value card 110 and created the time of manufacture of the card.
The card balance is able to be checked by a consumer or a merchant prior to initiating a financial transaction.
Validation of stored value card 110 does not use require the use of a merchant POS or financial network.
The integrity of stored value card 110 does not dependent solely on the integrity of the information on or in the card.
Multiple validation methods available to utilise as required.
As time and location data of cards being captured and held in database 148, fraudulent activity patterns are able to be detected based on this data.
System 100 is an open network in that there is no requirement for stored value card 110 to be assigned to a registered user's account in order to be used, thus supporting total anonymity.

As such, system 100 provides a secure stored value card where the card information can be verified at any point prior to purchase of the card, before activation and use of the card and after use of the card, thereby providing superior card integrity and surety to consumers, vendors and merchants.

### Conclusions and Interpretation

Throughout this specification, where used, the terms “element” and “component” are intended to mean either a single unitary component or a collection of components that combine to perform a specific function or purpose.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, for example, from registers and/or memory to transform that electronic data into other electronic data that, for example, may be stored in registers and/or memory. A “computer” or a “computing machine” or a “computing platform” may include one or more processors.

Some methodologies or portions of methodologies described herein are, in one embodiment, performable by one or more processors that accept computer-readable (also called machine-readable) code containing a set of instructions that when executed by one or more of the processors carry out at least one of the methods described herein. A memory subsystem of a processing system includes a computer-readable carrier medium that carries computer-readable code (for example, software) including a set of instructions to cause performing, when executed by one or more processors, one of more of the methods described herein. Note that when the method includes several elements, for example, several steps, no ordering of such elements is implied, unless specifically stated. The software may reside in the storage medium, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, unless otherwise specified, the one or more processors operate as a standalone device or may be connected, for example, networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while only a single processor and a single memory that carries the computer-readable code may be shown herein, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein, unless otherwise specified.

Thus, one embodiment of each of the methods described herein is in the form of a computer-readable carrier medium carrying a set of instructions, for example, a computer program that is for execution on one or more processors, for example, one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, for example, a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (for example, a computer program product on a computer-readable storage medium) carrying computer-readable program code embodied in the medium.

The software may further be transmitted or received over a network via a network interface device. While the carrier medium may be shown in an embodiment to be a single medium, the term “carrier medium” should be taken to include a single medium or multiple media (for example, a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage.

### Industrial Applicability

The arrangements described are applicable to the retail industry and, and particularly to technological devices used for retail transactions. However, it will also be appreciated that the arrangement described herein can also be applicable in other adjacent fields such as its use in SIM cards. Therefore, the invention is clearly industrially applicable.

1. A stored value card validation system including:
a stored value card having a plurality of activation states including an activated state and an unactivated state, the stored value card including: an encrypted token; a predefined card value; and a card identifier, whereby the predefined card value can be utilised for a transaction if the card is in the activated state and cannot be utilised for a transaction if the card is in the unactivated state;
a token reader for retrieving the encrypted token from the stored value card; and
a token validator in communication with the token reader for receiving the encrypted token and using the encrypted token to validate the predefined card value and the card identifier, the token validator having at least one database for storing card value information and card identifier information, wherein the predefined card value and the card identifier are each validated based on the card value information and card identifier information when the stored value card is in the unactivated state, further wherein the stored value card is able to be activated and/or validated without being connected to a registered user of the system.

2. The card value validation system according to claim 1 wherein the token reader includes a display for outputting a status of the stored value card, wherein the status is one of: a validated status whereby the predefined card value and the card identifier are successfully validated; and an unvalidated status whereby the predefined card value and the card identifier not successfully validated.

3. The card value validation system according to claim 1 wherein the stored value card includes a QR code and the token reader retrieves the token by reading the QR code.

4. The card value validation system according to claim 1 wherein the stored value card includes a magnetic stripe and the token reader retrieves the token by reading the magnetic stripe.

5. The card value validation system according to claim 1 wherein the stored value card includes an embedded passive RFID tag and the token reader retrieves the token by reading the RFID tag.

6. The card value validation system according to claim 1 wherein the stored value card includes an embedded active transmitter and the token reader retrieves the token by receiving a transmitted signal from the transmitter.

7. The card value validation system according to claim 1 including a secure communication channel for facilitating communication between the token reader and the token validator.

8. The card value validation system according to claim 1 wherein the token reader is a smartphone having a dedicated reader software application.

9. The card value validation system according to claim 1 wherein the token reader is a scanning device coupled to one or more of:
a computer system; or
a kiosk.

10. (canceled)

11. The card value validation system according to claim 1 wherein the predefined card value and the card identifier are each validated based on the card value information and card identifier information when the stored value card is in the activated state.

12. A method for validating a stored value card having a plurality of activation states including an activated state and an unactivated state, the stored value card including: an encrypted token; a predefined card value; and a card identifier, whereby the predefined card value can be utilised for a transaction if the card is in the activated state and cannot be utilised for a transaction if the card is in the unactivated state, the method including the steps of:
retrieving, by a token reader, the encrypted token from the stored value card;
receiving, by a token validator in communication with the token reader, the encrypted token; and
validating, by the token validator using the encrypted token, the predefined card value and the card identifier, the token validator having at least one database for storing card value information and card identifier information, wherein the predefined card value and the card identifier are each validated based on the card value information and card identifier information when the stored value card is in the unactivated state, further wherein the stored value card is able to be activated and/or validated without being connected to a registered user of the system.

13. The method according to claim 12 wherein the token reader includes a display, the method includes the further step of:
outputting on the display a status of the stored value card, wherein the status is one of:
a validated status whereby the predefined card value and the card identifier are successfully validated; and an unvalidated status whereby the predefined card value and the card identifier not successfully validated.

14. The method according to claim 12 wherein the stored value card includes a QR code and the retrieving step includes the token reader retrieving the token by reading the QR code.

15. The method according to claim 12 wherein the stored value card includes a magnetic stripe and the retrieving step includes the token reader retrieving the token by reading the magnetic stripe.

16. The method according to claim 12 wherein the stored value card includes an embedded passive RFID tag and the retrieving step includes the token reader retrieving the token by reading the RFID tag.

17. The method according to claim 12 wherein the stored value card includes an embedded active transmitter and the retrieving step includes the token reader retrieving the token by receiving a transmitted signal from the transmitter.

18. The method according to claim 12 wherein communication between the token reader and the token validator is facilitated by a secure communication channel.

19. The method according to claim 12 wherein the token reader is a smartphone having a dedicated reader software application.

20. The method according to claim 12 wherein the token reader is a scanning device coupled to a computer system.

21. (canceled)

22. The method according to claim 12 wherein the predefined card value and the card identifier are each validated based on the card value information and card identifier information when the stored value card is in the activated state.
